(19) United States
(12) Patent Application Publication
(10) Pub. No.: US 2024/0355042 A1
(43) Pub. Date: Oct. 24, 2024

(54) FUSING NEURAL RADIANCE FIELDS BY REGISTRATION AND BLENDING

(71) Applicants: TOYOTA RESEARCH INSTITUTE, INC., Los Altos, CA (US); TOYOTA TECHNOLOGICAL INSTITUTE AT CHICAGO, Chicago, IL (US)

(72) Inventors: Jiading FANG, Chicago, IL (US); Shengjie LIN, Chicago, IL (US); Igor VASILJEVIC, San Mateo, CA (US); Vitor Campagnolo GUIZILINI, Santa Clara, CA (US); Rares Andrei AMBRUS, San Francisco, CA (US); Adrien David GAIDON, Mountain View, CA (US); Gregory SHAKHNAROVICH, Chicago, IL (US); Matthew WALTER, Chicago, IL (US)

(73) Assignees: TOYOTA RESEARCH INSTITUTE, INC., Los Altos, CA (US); TOYOTA JIDOSHA KABUSHIKI KAISHA, Aichi-Ken (JP); TOYOTA TECHNOLOGICAL INSTITUTE AT CHICAGO, Chicago, IL (US)

(21) Appl. No.: 18/429,137

(22) Filed: Jan. 31, 2024

Related U.S. Application Data
(60) Provisional application No. 63/460,845, filed on Apr. 20, 2023.

(51) Int. Cl. G06T 15/50

(52) U.S. Cl. CPC G06T 15/503

(57) ABSTRACT

A method for fusing neural radiance fields (NeRFs) is described. The method includes re-rendering a first NeRF and a second NeRF at different viewpoints to form synthesized images from the first NeRF and the second NeRF. The method also includes inferring a transformation between a re-rendered first NeRF and a re-rendered second NeRF based on the synthesized images from the first NeRF and the second NeRF. The method further includes blending the re-rendered first NeRF and the re-rendered second NeRF based on the inferred transformation to fuse the first NeRF and the second NeRF.

### CROSS-REFERENCE TO RELATED APPLICATION

The present application claims the benefit of U.S. Provisional Patent Application No. 63/460,845, filed Apr. 20, 2023, and titled “NERFUSER: FUSING NERFS BY REGISTRATION AND BLENDING,” the disclosure of which is expressly incorporated by reference herein in its entirety.

### BACKGROUND

### Field

Certain aspects of the present disclosure relate to machine learning and, more particularly, fusing neural radiance fields (NeRFs) by registration and blending.

### Background

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene. That is, machine vision strives to provide a high-level understanding of a surrounding environment, as performed by the human visual system.

The transmission of visual data relies on efficient video and image encoding and decoding, technologies with decades of development behind them. Most computer vision methods and tools are specialized to this type of data. Methods that align and blend images are ubiquitous and fundamentally designed to work on explicit 2D representations of images. Neural radiance fields (NeRFs) allow for efficient visual compression and impressive view synthesis, generating a potentially infinite set of views from a fixed set of training images. Despite the promise of this representation as a storage and communication format, there is a lack of tools that treat NeRFs as data, much like common image processing tools treat images. A method for fusing NeRFs by registration and blending is desired.

### SUMMARY

A method for fusing neural radiance fields (NeRFs) is described. The method includes re-rendering a first NeRF and a second NeRF at different viewpoints to form synthesized images from the first NeRF and the second NeRF. The method also includes inferring a transformation between a re-rendered first NeRF and a re-rendered second NeRF based on the synthesized images from the first NeRF and the second NeRF. The method further includes blending the re-rendered first NeRF and the re-rendered second NeRF based on the inferred transformation to fuse the first NeRF and the second NeRF.

A non-transitory computer-readable medium having program code recorded thereon for fusing neural radiance fields (NeRFs) is described. The program code is executed by a processor. The non-transitory computer-readable medium includes program code to re-render a first NeRF and a second NeRF at different viewpoints to form synthesized images from the first NeRF and the second NeRF. The non-transitory computer-readable medium also includes program code to infer a transformation between a re-rendered first NeRF and a re-rendered second NeRF based on the synthesized images from the first NeRF and the second NeRF. The non-transitory computer-readable medium further includes program code to blend the re-rendered first NeRF and the re-rendered second NeRF based on the inferred transformation to fuse the first NeRF and the second NeRF.

A system for fusing neural radiance fields (NeRFs) is described. The system includes re-render module to re-render a first NeRF and a second NeRF at different viewpoints to form synthesized images from the first NeRF and the second NeRF. The system also includes transform inference model to infer a transformation between a re-rendered first NeRF and a re-rendered second NeRF based on the synthesized images from the first NeRF and the second NeRF. The system further includes NeRF blending module to blend the re-rendered first NeRF and the re-rendered second NeRF based on the inferred transformation to fuse the first NeRF and the second NeRF.

This has outlined, broadly, the features and technical advantages of the present disclosure in order that the detailed description that follows may be better understood. Additional features and advantages of the present disclosure will be described below. It should be appreciated by those skilled in the art that the present disclosure may be readily utilized as a basis for modifying or designing other structures for conducting the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a system using a system-on-a-chip (SOC) for fusing neural radiance fields (NeRFs) by registration and blending, in accordance with aspects of the present disclosure.

FIG. 2 is a block diagram illustrating a software architecture for fusing neural radiance fields (NeRFs) by registration and blending, according to aspects of the present disclosure.

FIG. 3 is a diagram illustrating an example of a hardware implementation of a neural radiance field (NeRF) fusion framework system for registration and blending of pre-trained NeRFs, according to various aspects of the present disclosure.

FIG. 4 is a block diagram illustrating a neural radiance field (NeRF) fusion pipeline for the registration and blending of pre-trained NeRFs, according to various aspects of the present disclosure.

FIG. 5 provides an illustration of how ray samples proposed by two NeRFs are merged based on their locations and lengths, according to various aspects of the present disclosure.

FIG. 6 shows an illustration of IDW-based blending methods, according to various aspects of the present disclosure.

FIG. 7 illustrates a qualitative comparison of the blending methods shown in FIG. 6, according to various aspects of the present disclosure.

FIG. 8 is a flowchart illustrating a method for fusing neural radiance fields (NeRFs), according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

Based on the teachings, one skilled in the art should appreciate that the scope of the present disclosure is intended to cover any aspect of the present disclosure, whether implemented independently of or combined with any other aspect of the present disclosure. For example, an apparatus may be implemented, or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure disclosed may be embodied by one or more elements of a claim.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses, or objectives. Rather, aspects of the present disclosure are intended to be universally applicable to different technologies, system configurations, networks, and protocols, some of which are illustrated by way of example in the figures and in the following description of the preferred aspects. The detailed description and drawings are merely illustrative of the present disclosure, rather than limiting the scope of the present disclosure being defined by the appended claims and equivalents thereof.

Autonomous agents (e.g., robots, etc.) rely on machine vision for sensing a surrounding environment by analyzing areas of interest in images of the surrounding environment. Although scientists have spent decades studying the human visual system, a solution for realizing equivalent machine vision remains elusive. Realizing equivalent machine vision is a goal for enabling truly autonomous agents. Machine vision is distinct from the field of digital image processing because of the desire to recover a three-dimensional (3D) structure of the world from images and using the 3D structure for fully understanding a scene.

The ability of machine vision to provide a high-level understanding of a surrounding environment may involve the transmission of significant amounts of visual data. In practice, the transmission of visual data relies on efficient video and image encoding and decoding technologies with decades of development behind the technologies. Most computer vision methods and tools are specialized to this type of data. Methods that align and blend images are ubiquitous and fundamentally designed to work on explicit 2D representations of images.

Nevertheless, in recent years neural fields have emerged as a new learning-based representation for visual data. Pioneered by neural radiance fields (NeRFs), the implicit representations of neural fields allow for efficient visual compression and impressive view synthesis, generating a potentially infinite set of views from a fixed set of training images. Despite the promise of this representation as a storage and communication format, there is a lack of tools that treat neural radiance fields (NeRFs) as data, much like common image processing tools treat images. In particular, a practical benefit of implicit visual representations, such as NeRFs is their memory efficiency: large scenes can be efficiently stored and shared as small neural nets instead of collections of images. Even so, operating on these implicit visual data structures involves extending classical image-based vision techniques (e.g., registration, blending) from image sets to neural fields.

Towards this goal, various aspects of the present disclosure are directed to NeRFuser, a novel architecture for NeRF registration and blending that assumes only access to pre-generated NeRFs, and not the potentially large sets of images used to generate the NeRFs. These aspects of the present disclosure propose registration from re-rendering, a technique to infer the transformation between NeRFs based on images synthesized from individual NeRFs. For blending, a sample-based inverse distance weighting is proposed to blend visual information at the ray-sample level. Additionally, NeRFuser is evaluated on public benchmarks and a self-collected object-centric indoor dataset, showing the robustness of our method, including to views that are challenging to render from the individual source NeRFs.

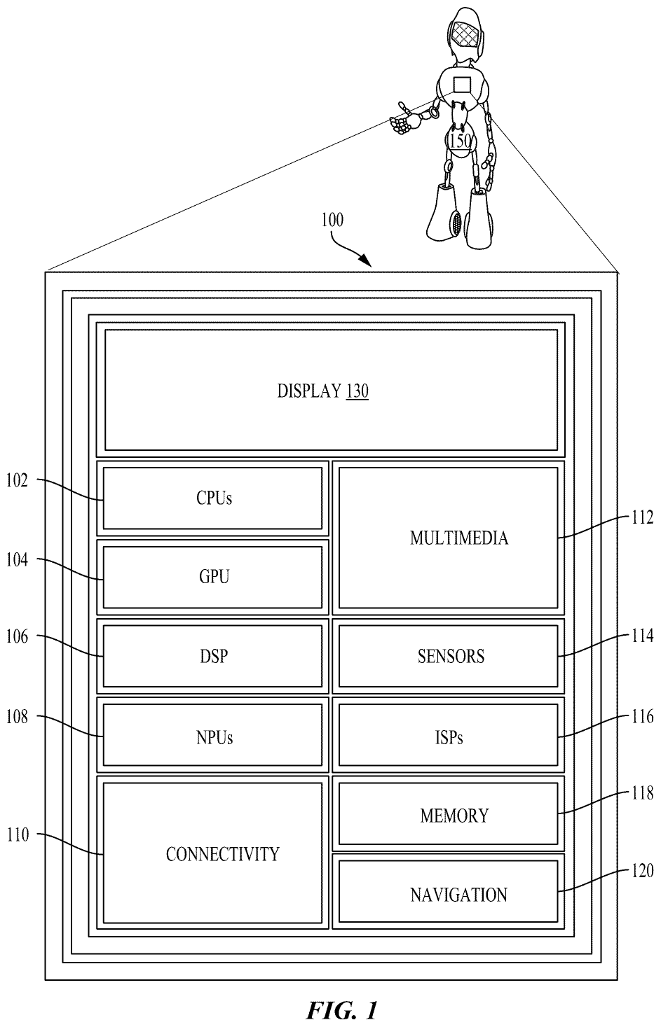

FIG. 1 illustrates an example implementation of the aforementioned system and method for fusing neural radiance fields (NeRFs) by registration and blending using a system-on-a-chip (SOC) 100 of a robot 150. The SOC 100 may include a single processor or multi-core processors (e.g., a central processing unit), in accordance with certain aspects of the present disclosure. Variables (e.g., neural signals and synaptic weights), system parameters associated with a computational device (e.g., neural network with weights), delays, frequency bin information, and task information may be stored in a memory block. The memory block may be associated with a neural processing unit (NPU) 108, a CPU 102, a graphics processing unit (GPU) 104, a digital signal processor (DSP) 106, a dedicated memory block 118, or may be distributed across multiple blocks. Instructions executed at a processor (e.g., CPU 102) may be loaded from a program memory associated with the CPU 102 or may be loaded from the dedicated memory block 118.

The SOC 100 may also include additional processing blocks configured to perform specific functions, such as the GPU 104, the DSP 106, and a connectivity block 110, which may include fourth generation long term evolution (4G LTE) connectivity, unlicensed Wi-Fi connectivity, USB connectivity, Bluetooth® connectivity, and the like. In addition, a multimedia processor 112 in combination with a display 130 may, for example, classify and categorize poses of objects in an area of interest, according to the display 130 illustrating a view of a robot. In some aspects, the NPU 108 may be implemented in the CPU 102, DSP 106, and/or GPU 104. The SOC 100 may further include a sensor processor 114, image signal processors (ISPs) 116, and/or navigation 120, which may, for instance, include a global positioning system.

The SOC 100 may be based on an Advanced Risk Machine (ARM) instruction set or the like. In another aspect of the present disclosure, the SOC 100 may be a server computer in communication with the robot 150. In this arrangement, the robot 150 may include a processor and other features of the SOC 100. In this aspect of the present disclosure, instructions loaded into a processor (e.g., CPU 102) or the NPU 108 of the robot 150 may include code for fusing neural radiance fields (NeRFs) by registration and blending in a NeRF fusion framework from images captured by the sensor processor 114. The instructions loaded into a processor (e.g., CPU 102) may also include code for planning and control (e.g., of the robot 150) in response to fusing NeRFs by registration and blending from images captured by the sensor processor 114.

The instructions loaded into a processor (e.g., CPU 102) may also include code to re-render a first NeRF and a second NeRF at different viewpoints to synthesize images from the first NeRF and the second NeRF. The instructions loaded into a processor (e.g., CPU 102) may also include code to infer a transformation between a re-rendered first NeRF and a re-rendered second NeRF based on the synthesized images from the first NeRF and the second NeRF. The instructions loaded into a processor (e.g., CPU 102) may further include code to blend the re-rendered first NeRF and the re-rendered second NeRF based on the inferred transformation to fuse the first NeRF and the second NeRF. The instructions loaded into a processor (e.g., CPU 102) may also include code to plan an object grasp by a robot according to a fused image from the first NeRF and the second NeRF.

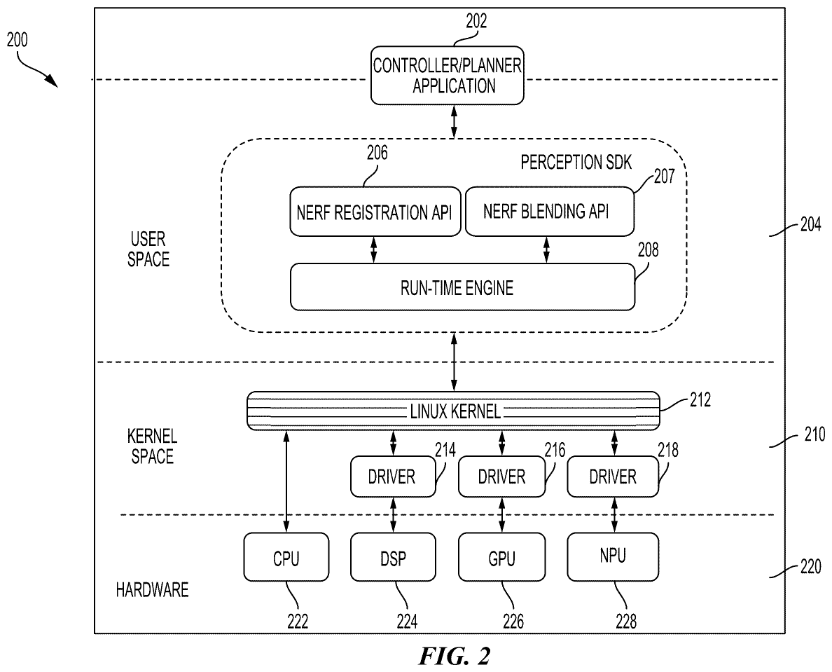

FIG. 2 is a block diagram illustrating a software architecture 200 for fusing neural radiance fields (NeRFs) by registration and blending in a NeRF fusion framework, according to aspects of the present disclosure. Using the software architecture 200, a controller/planner application 202 may be designed such that it may cause various processing blocks of an SOC 220 (for example a CPU 222, a DSP 224, a GPU 226, and/or an NPU 228) to perform supporting computations during run-time operation of the controller/planner application 202.

The controller/planner application 202 may be configured to call functions defined in a user space 204 that may, for example, utilize NeRFs as a data representation. Various aspects of the present disclosure are directed to NeRFuser, a novel architecture for NeRF registration and blending that assumes access to pre-generated NeRFs, and not the potentially large sets of images used to generate the NeRFs. These aspects of the present disclosure propose registration from re-rendering, a technique to infer the transformation between NeRFs based on images synthesized from individual NeRFs. For blending, a sample-based inverse distance weighting is proposed to blend visual information at the ray-sample level.

In various aspects of the present disclosure, the controller/planner application 202 may make a request to compile program code associated with a library defined in a NeRF registration application programming interface (API) 206 to re-render a first NeRF and a second NeRF at different viewpoints to synthesize images from the first NeRF and the second NeRF. The NeRF registration API 206 may also infer a transformation between a re-rendered first NeRF and a re-rendered second NeRF based on the synthesized images from the first NeRF and the second NeRF. Additionally, a NeRF blending API 207 may manipulate and blend the re-rendered first NeRF and the re-rendered second NeRF based on the inferred transformation to fuse the first NeRF and the second NeRF to form a fused image from the first NeRF and the second NeRF.

A run-time engine 208, which may be compiled code of a run-time framework, may be further accessible to the controller/planner application 202. The controller/planner application 202 may cause the run-time engine 208, for example, to perform object manipulation utilizing NeRFs as a data representation. When an object is detected within a predetermined distance of the robot, the run-time engine 208 may in turn send a signal to an operating system 210, such as a Linux Kernel 212, running on the SOC 220. The operating system 210, in turn, may cause a computation to be performed on the CPU 222, the DSP 224, the GPU 226, the NPU 228, or some combination thereof. The CPU 222 may be accessed directly by the operating system 210, and other processing blocks may be accessed through a driver, such as drivers 214-218 for the DSP 224, for the GPU 226, or for the NPU 228. In the illustrated example, the deep neural network may be configured to run on a combination of processing blocks, such as the CPU 222 and the GPU 226, or may be run on the NPU 228, if present.

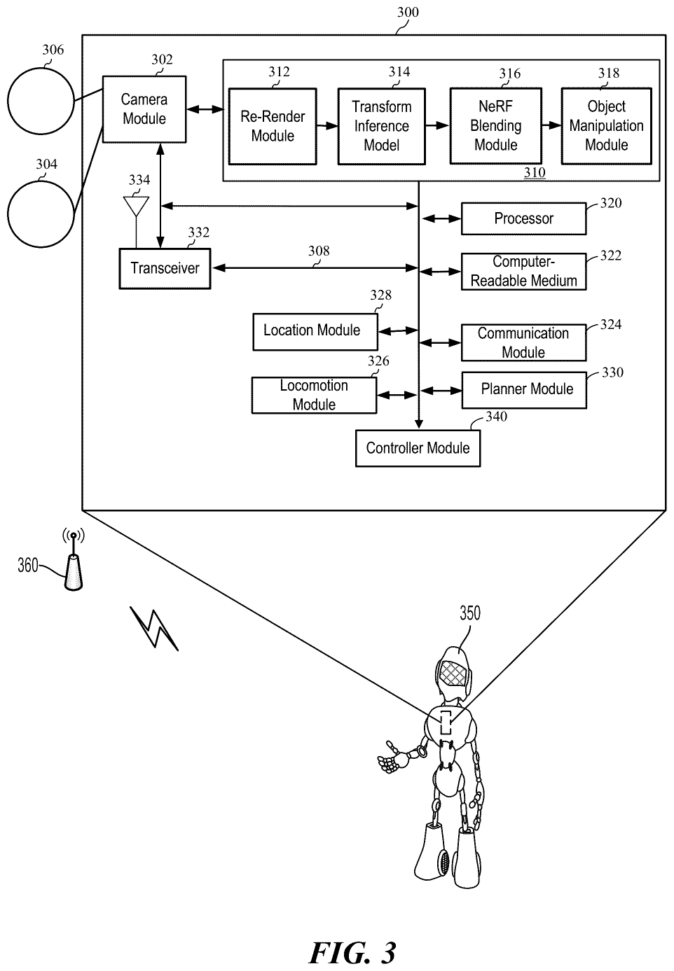

FIG. 3 is a diagram illustrating an example of a hardware implementation of a neural radiance field (NeRF) fusion framework system 300 for registration and blending of pre-trained NeRFs, according to various aspects of the present disclosure. The NeRF fusion framework system 300 may be configured for understanding a scene to enable planning and controlling a robot in response to images from video captured through a camera during operation of a robot 350. The NeRF fusion framework system 300 may be a component of a robotic or other autonomous device. For example, as shown in FIG. 3, the NeRF fusion framework system 300 is a component of the robot 350. Aspects of the present disclosure are not limited to the NeRF fusion framework system 300 being a component of the robot 350, as other devices, such as a vehicle, a bus, a motorcycle, or other like autonomous vehicles, are also contemplated for using the NeRF fusion framework system 300. The robot 350 may be autonomous or semi-autonomous.

The NeRF fusion framework system 300 may be implemented with an interconnected architecture, such as a controller area network (CAN) bus, represented by an interconnect 308. The interconnect 308 may include any number of point-to-point interconnects, buses, and/or bridges depending on the specific application of the NeRF fusion framework system 300 and the overall design constraints of the robot 350. The interconnect 308 links together various circuits, including one or more processors and/or hardware modules, represented by a camera module 302, a perception module 310, a processor 320, a computer-readable medium 322, a communication module 324, a locomotion module 326, a location module 328, a planner module 330, and a controller module 340. The interconnect 308 may also link various other circuits such as timing sources, peripherals, voltage regulators, and power management circuits, which are well known in the art, and therefore, will not be described any further.

The NeRF fusion framework system 300 includes a transceiver 332 coupled to the camera module 302, the perception module 310, the processor 320, the computer-readable medium 322, the communication module 324, the locomotion module 326, the location module 328, a planner module 330, and the controller module 340. The transceiver 332 is coupled to an antenna 334. The transceiver 332 communicates with various other devices over a transmission medium. For example, the transceiver 332 may receive commands via transmissions from a user or a remote device. As discussed herein, the user may be in a location that is remote from the location of the robot 350. As another example, the transceiver 332 may transmit fused NeRFs within a video and/or planned actions from the perception module 310 to a server (not shown).

The NeRF fusion framework system 300 includes the processor 320 coupled to the computer-readable medium 322. The processor 320 performs processing, including the execution of software stored on the computer-readable medium 322 to provide functionality, according to the present disclosure. The software, when executed by the processor 320, causes the NeRF fusion framework system 300 to perform the various functions described for robotic perception of fused NeRFs from scenes in video captured by a camera of an autonomous agent, such as the robot 350, or any of the modules (e.g., 302, 310, 324, 326, 328, 330, and/or 340). The computer-readable medium 322 may also be used for storing data that is manipulated by the processor 320 when executing the software.

The camera module 302 may obtain images via different cameras, such as a first camera 304 and a second camera 306. The first camera 304 and the second camera 306 may be a vision sensors (e.g., a stereoscopic camera or a red-green-blue (RGB) camera) for capturing 2D RGB images. Alternatively, the camera module may be coupled to a ranging sensor, such as a light detection and ranging (LIDAR) sensor or a radio detection and ranging (RADAR) sensor. Of course, aspects of the present disclosure are not limited to the aforementioned sensors, as other types of sensors (e.g., thermal, sonar, and/or lasers) are also contemplated for either of the first camera 304 or the second camera 306.

The images of the first camera 304 and/or the second camera 306 may be processed by the processor 320, the camera module 302, the perception module 310, the communication module 324, the locomotion module 326, the location module 328, and the controller module 340. In conjunction with the computer-readable medium 322, the images from the first camera 304 and/or the second camera 306 are processed to implement the functionality described herein. In one configuration, detected 2D object information captured by the first camera 304 and/or the second camera 306 may be transmitted via the transceiver 332. The first camera 304 and the second camera 306 may be coupled to the robot 350 or may be in communication with the robot 350.

A practical benefit of implicit visual representations, such as neural radiance fields (NeRFs) is their memory efficiency: large scenes can be efficiently stored and shared as small neural nets instead of collections of images. Nevertheless, operating on these implicit visual data structures requires extending classical image-based vision techniques (e.g., registration, blending) from image sets to neural fields. Towards this goal, the NeRF fusion framework system 300 provides a novel architecture for NeRF registration and blending that assumes only access to pre-generated NeRFs, and not the potentially large sets of images used to generate the NeRFs. These aspects of the present disclosure propose registration from re-rendering, a technique to infer the transformation between NeRFs based on images synthesized from individual NeRFs. For blending, a sample-based inverse distance weighting is proposed to blend visual information at the ray-sample level.

The location module 328 may determine a location of the robot 350. For example, the location module 328 may use a global positioning system (GPS) to determine the location of the robot 350. The location module 328 may implement a dedicated short-range communication (DSRC)-compliant GPS unit. A DSRC-compliant GPS unit includes hardware and software to make the robot 350 and/or the location module 328 compliant with one or more of the following DSRC standards, including any derivative or fork thereof: EN 12253:2004 Dedicated Short-Range Communication-Physical layer using microwave at 5.9 GHZ (review); EN 12795:2002 Dedicated Short-Range Communication (DSRC)-DSRC Data link layer: Medium Access and Logical Link Control (review); EN 12834:2002 Dedicated Short-Range Communication-Application layer (review); EN 13372:2004 Dedicated Short-Range Communication (DSRC)-DSRC profiles for RTTT applications (review); and EN ISO 14906:2004 Electronic Fee Collection-Application interface.

A DSRC-compliant GPS unit within the location module 328 is operable to provide GPS data describing the location of the robot 350 with space-level accuracy for accurately directing the robot 350 to a desired location. For example, the robot 350 is moving to a predetermined location and desires partial sensor data. Space-level accuracy means the location of the robot 350 is described by the GPS data sufficient to confirm a location of the robot 350 parking space. That is, the location of the robot 350 is accurately determined with space-level accuracy based on the GPS data from the robot 350.

The communication module 324 may facilitate communications via the transceiver 332. For example, the communication module 324 may be configured to provide communication capabilities via different wireless protocols, such as Wi-Fi, long term evolution (LTE), 3G, etc. The communication module 324 may also communicate with other components of the robot 350 that are not modules of the NeRF fusion framework system 300. The transceiver 332 may be a communications channel through a network access point 360. The communications channel may include DSRC, LTE, LTE-D2D, mmWave, Wi-Fi (infrastructure mode), Wi-Fi (ad-hoc mode), visible light communication, TV white space communication, satellite communication, full-duplex wireless communications, or any other wireless communications protocol such as those mentioned herein.

In some configurations, the network access point 360 includes Bluetooth® communication networks or a cellular communications network for sending and receiving data, including via short messaging service (SMS), multimedia messaging service (MMS), hypertext transfer protocol (HTTP), direct data connection, wireless application protocol (WAP), e-mail, DSRC, full-duplex wireless communications, mmWave, Wi-Fi (infrastructure mode), Wi-Fi (ad-hoc mode), visible light communication, TV white space communication, and satellite communication. The network access point 360 may also include a mobile data network that may include 3G, 4G, 5G, LTE, LTE-V2X, LTE-D2D, VOLTE, or any other mobile data network or combination of mobile data networks. Further, the network access point 360 may include one or more IEEE 802.11 wireless networks.

The NeRF fusion framework system 300 also includes the planner module 330 for planning a selected trajectory to perform a route/action (e.g., collision avoidance) of the robot 350 and the controller module 340 to control the locomotion of the robot 350. The controller module 340 may perform the selected action via the locomotion module 326 for autonomous operation of the robot 350 along, for example, a selected route. In one configuration, the planner module 330 and the controller module 340 may collectively override a user input when the user input is expected (e.g., predicted) to cause a collision according to an autonomous level of the robot 350. The modules may be software modules running in the processor 320, resident/stored in the computer-readable medium 322, and/or hardware modules coupled to the processor 320, or some combination thereof.

The National Highway Traffic Safety Administration (NHTSA) has defined different “levels” of autonomous agents (e.g., Level 0, Level 1, Level 2, Level 3, Level 4, and Level 5). For example, if an autonomous agent has a higher-level number than another autonomous agent (e.g., Level 3 is a higher-level number than Levels 2 or 1), then the autonomous agent with a higher-level number offers a greater combination and quantity of autonomous features relative to the agent with the lower-level number. These distinct levels of autonomous agents are described briefly below.

Level 0: In a Level 0 agent, the set of advanced driver assistance system (ADAS) features installed in an agent provide no agent control but may issue warnings to the driver of the agent. An agent which is Level 0 is not an autonomous or semi-autonomous agent.

Level 1: In a Level 1 agent, the driver is ready to take operation control of the autonomous agent at any time. The set of ADAS features installed in the autonomous agent may provide autonomous features such as: adaptive cruise control (ACC); parking assistance with automated steering; and lane keeping assistance (LKA) type II, in any combination.

Level 2: In a Level 2 agent, the driver is obliged to detect objects and events in the roadway environment and respond if the set of ADAS features installed in the autonomous agent fail to respond properly (based on the driver's subjective judgement). The set of ADAS features installed in the autonomous agent may include accelerating, braking, and steering. In a Level 2 agent, the set of ADAS features installed in the autonomous agent can deactivate immediately upon takeover by the driver.

Level 3: In a Level 3 ADAS agent, within known, limited environments (such as freeways), the driver can safely turn their attention away from operation tasks but must still be prepared to take control of the autonomous agent when needed.

Level 4: In a Level 4 agent, the set of ADAS features installed in the autonomous agent can control the autonomous agent in all but a few environments, such as severe weather. The driver of the Level 4 agent enables the automated system (which is comprised of the set of ADAS features installed in the agent) only when it is safe to do so. When the automated Level 4 agent is enabled, driver attention is not required for the autonomous agent to operate safely and consistent within accepted norms.

Level 5: In a Level 5 agent, other than setting the destination and starting the system, no human intervention is involved. The automated system can drive to any location where it is legal to drive and make its own decision (which may vary based on the district where the agent is located).

A highly autonomous agent (HAA) is an autonomous agent that is Level 3 or higher. Accordingly, in some configurations the robot 350 is one of the following: a Level 0 non-autonomous agent; a Level 1 autonomous agent; a Level 2 autonomous agent; a Level 3 autonomous agent; a Level 4 autonomous agent; a Level 5 autonomous agent; and an HAA.

The perception module 310 may be in communication with the camera module 302, the processor 320, the computer-readable medium 322, the communication module 324, the locomotion module 326, the location module 328, the planner module 330, the transceiver 332, and the controller module 340. In one configuration, the perception module 310 receives sensor data from the camera module 302. The camera module 302 may receive RGB video image data from the first camera 304 and the second camera 306. According to aspects of the present disclosure, the perception module 310 may receive RGB video image data directly from the first camera 304 or the second camera 306 to manipulate unknown objects from images captured by the first camera 304 and the second camera 306 of the robot 350.

As shown in FIG. 3, the perception module 310 includes a re-render module 312, a transform inference model 314, a NeRF blending module 316, and an object manipulation module 318. The re-render module 312, the transform inference model 314, the NeRF blending module 316, and the object manipulation module 318 may be components of a same or different artificial neural network, such as a convolutional neural network (CNN). The modules (e.g., 312, 314, 316, 318) of the perception module 310 are not limited to a CNN. In operation, the perception module 310 receives a video stream from the first camera 304 and the second camera 306. The video stream may include a 2D RGB left image from the first camera 304 and a 2D RGB right image from the second camera 306 to provide video frame images. The video stream may include multiple frames, such as image frames.

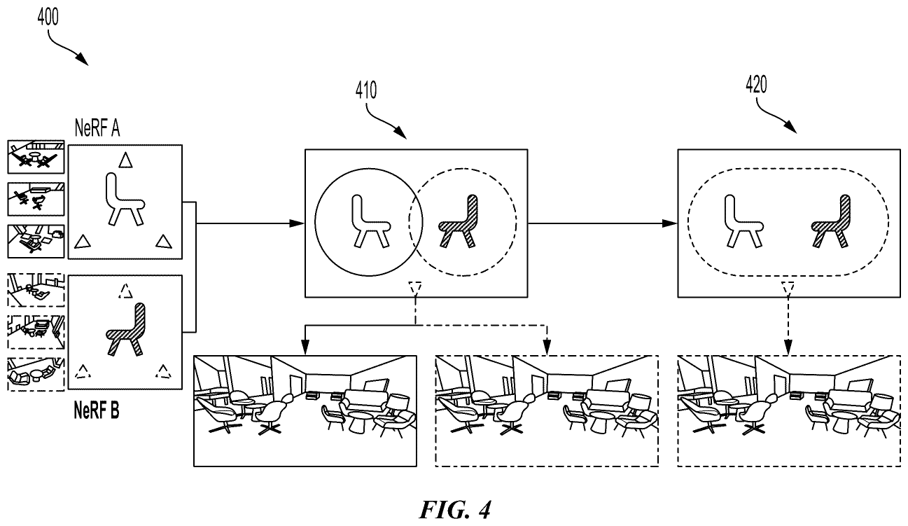

In some aspects of the present disclosure, the perception module 310 is configured for fusing NeRFs by registration and blending in a NeRF fusion pipeline. The perception module 310 includes the re-render module 312 to re-render a first NeRF and a second NeRF at different viewpoints to synthesize images from the first NeRF and the second NeRF. Additionally, the perception module 310 includes the transform inference model 314 to infer a transformation between a re-rendered first NeRF and a re-rendered second NeRF based on the synthesized images from the first NeRF and the second NeRF. In various aspect of the present disclosure, the perception module 310 includes the NeRF blending module 316 to blend the re-rendered first NeRF and the re-rendered second NeRF based on the inferred transformation to fuse the first NeRF and the second NeRF. Additionally, the perception module 310 includes the object manipulation module 318 to plan an object grasp by a robot according to a fused image from the first NeRF and the second NeRF. The fusing of NeRFs by registration and blending in a NeRF fusion framework is further illustrated, for example, as shown in FIG. 4.

FIG. 4 is a block diagram illustrating a neural radiance field (NeRF) fusion pipeline 400 for the registration and blending of pre-trained NeRFs, according to various aspects of the present disclosure. Treating input NeRFs as black boxes (i.e., raw data), without access to the images that generate them, various aspects of the present disclosure can register NeRFs (in both pose and scale) and render images from blended NeRFs. As shown in FIG. 4, starting from separately constructed input NeRFs, NeRF A and NeRF B, at step 410 images of NeRF A and NeRF B are rendered at novel viewpoints, including those not well-covered by either NeRF A or NeRF B. In various aspects of the present disclosure, the registration through re-rendering at step 410 is followed by a novel blending procedure at step 420, which leads to a higher quality result (lower right) than rendered from the original NeRFs (NeRF A or NeRF B).

Removing the specification for source images also greatly reduces memory consumption. A typical scene may be captured by one hundred (100) images, each about one (1) megabyte (MB) in size. In contrast, a NeRF, which acts as a compression of individual images, provides an implicit representation of the scene that takes up approximately 5 MB, a substantial (e.g., 20×) reduction from the set of original images. Directly transferring this implicit representation makes it possible to build real-time 3D capturing applications (e.g., NeRF streaming), for example, as shown in FIG. 4.

As shown in FIG. 4, the NeRF fusion pipeline 400 fuses NeRFs in two steps: registration at step 410 and blending at step 420. For the first step 410, a registration from re-rendering process is described. This registration from re-rendering process takes advantage of the ability of modern NeRFs to synthesize high-quality views, which enables making use of a 2D image matching pipeline for the 3D NeRF registration task. For the second step 420, a fine-grained sample-based blending method, including a novel compatible weighting method is provided. In summary, (i) a novel registration from re-rendering method, which aligns uncalibrated implicit representations and solves for relative scale and pose; and (ii) a new blending method for compositing predictions from multiple NeRFs, resulting in blended images that are better than images rendered by any individual NeRF are described according to various aspects of the present disclosure.

### 1. Methodology

This section first describes a NeRF registration method: registration from re-rendering and then a blending technique: inverse-distance-weighting (IDW)-Sample, is described, according to various aspects of the present disclosure.

1.1 Registration from Re-Rendering

As shown in FIG. 4, the first step 410 of the NeRF fusion pipeline 400 is to estimate the relative transformations between two or more input NeRFs. It is assumed that each NeRF is trained on a separate set of images, capturing different, yet overlapping, portions of the same scene (e.g., each input NeRF has at least one neighbor NeRF). Conversely, a specific type of training data is not assumed (e.g., the poses used to train the NeRFs may have a metric scale, or they may be the result of a structure-from-motion (SfM) and, thus, have an arbitrary scale. As a result, each NeRF may have a unique coordinate system that is inconsistent with the others, in terms of translation and rotation as well as scale. Without loss of generality, the following discussion focuses on the registration of two NeRFs, A and B, as the extension to more than two NeRFs is straightforward.

These aspects of the present disclosure are directed to finding a transformation T_{BA}∈SIM(3) that transforms a 3D point pp in NeRF B to its corresponding point p_{B} in NeRF A as p_{B}=T_{BA}p_{B}. Note that

$${T}_{B A} = [ \begin{matrix}{R}_{B A} & {t}_{B A} \\ 0 & 1\end{matrix} ] {S}_{B A}$$

can be decomposed into a rotation R_{BA}, translation t_{BA}, and uniform scaling of factor s_{BA}, where S_{BA} is a diagonal matrix diag(s_{BA}, s_{BA}, s_{BA}, 1).

First, it is assumed that the NeRFs (e.g., NeRF A and NeRF B) are produced with sufficient training views, so that they can generate high quality novel views. Next, a set of poses are sampled (e.g., uniformly on the upper hemisphere), which are used as local poses to query both NeRFs to provide re-renderings. For example, re-purpose off-the-shelf structure-from-motion (SfM) methods are applied to the union of re-rendered images from the two NeRFs (e.g., NeRF A and NeRF B) in order to re-cover their poses in the same coordinate system, which are then used for registration, as discussed next.

Procedure and Notation Given the trained model of NeRF A, NeRF A is queried with sampled poses {G_{A}_{ᵢ}^{A}}ᵢ to synthesize images {I_{A}_{ᵢ}}ᵢ. G_{A}_{ᵢ}^{A}∈SE(3) is specified as a pose matrix that transforms a point from the coordinate system of camera Aᵢ to that of NeRF A. I_{A}_{ᵢ} is the image synthesized from NeRF A using the query pose G_{A}_{ᵢ}^{A}. Likewise, NeRF B is queried with {G_{B}_{ᵢ}^{B}}, to synthesize images {I_{B}_{ᵢ}}ᵢ. Next, images {I_{A}_{ᵢ}}ᵢ∪{I_{B}_{ᵢ}}ᵢ are fed, as input, to SIM, and poses {G_{A}_{ᵢ}^{C}}ᵢ and {G_{B}_{ᵢ}^{C}}ᵢ are obtained as output. G_{A}_{ᵢ}^{C}∈SE(3) is the recovered pose of image I_{A}_{ᵢ} from SfM. It is specified as a pose matrix that transforms a point from the coordinate frame of camera Aᵢ to C, where C is the coordinate system determined by this SfM execution. Note that an SE(3) pose matrix does not involve scale, so the induced camera-to-world transformation always assumes a specific camera instance that shares the same scale as the world.

Recovering Scale Let S_{AC}=diag (s_{AC}, s_{AC}, s_{AC}, 1) be the scale matrix from NeRF A to C, meaning that one unit length in NeRF A equals s_{A} units in C. Considering Gᵢⱼ∈SE(3) as the pose of camera Aᵢ relative to camera Aⱼ when specified in C's scale, the following poses are provided:

$$\begin{matrix}{G}_{i j} = {G}_{{A}_{j}}^{{C}^{- 1}} {G}_{{A}_{i}}^{C} & using C as bridge \\ = {S}_{A C} {G}_{{A}_{j}}^{{A}^{- 1}} {G}_{{A}_{i}}^{A} {{S}_{AC}}^{- 1} & using A as bridge\end{matrix} \qquad ( 2 )$$

If G_{A}_{ᵢ}^{C} as

$$[ \begin{matrix}{R}_{{A}_{i}}^{C} & {t}_{{A}_{i}}^{C} \\ 0 & 1\end{matrix} ]$$

is further dissected and repeated for G_{A}_{ⱼ}^{C}, G_{A}_{ᵢ}^{A}, G_{A}_{ⱼ}^{A}, Equation 2 becomes:

$$[ \begin{matrix}{R}_{{A}_{j}}^{{C}^{T}} {R}_{{A}_{i}}^{C} & {R}_{{A}_{j}}^{{C}^{T}} ( {t}_{{A}_{i}}^{C} - {t}_{{A}_{j}}^{C} ) \\ 0 & 1\end{matrix} ] = [ \begin{matrix}{R}_{{A}_{j}}^{{A}^{T}} {R}_{{A}_{i}}^{A} & {s}_{A C} {R}_{{A}_{j}}^{{A}^{T}} ( {t}_{{A}_{i}}^{A} - {t}_{{A}_{j}}^{A} ) \\ 0 & 1\end{matrix} ] . \qquad ( 3 )$$

Note that all components involved in Equation 3 are either determined when sampling camera poses or given by SfM with the exception of s_{AC}, which is what is being recovered. Specifically, equating the L2 norm of the translation part from both sides of Equation 3 gives:

$${S}_{A C} = \frac{{‖ {t}_{{A}_{i}}^{C} - {t}_{{A}_{j}}^{C} ‖}_{2}}{{‖ {t}_{{A}_{i}}^{A} - {t}_{{A}_{j}}^{A} ‖}_{2}} \qquad ( 4 )$$

In practice, the median over all i, j pairs is used to construct S_{AC}. S_{BC} is recovered similarly.

Recovering Transformations Let T_{AC}∈SIM(3) be the transformation from NeRF A to C. Using camera Aᵢ as bridge,

$${T}_{A C} = {G}_{{A}_{i}}^{C} {S}_{A C} {G}_{{A}_{i}}^{{A}^{- 1}} .$$

In practice, T_{AC} is computed over all instances of camera Aᵢ, and the closest valid SIM(3) transformation to the median result is chosen. T_{BC} is recovered similarly. Then NeRF B to NeRF A transformation is computed as T_{BA}=T_{AC}⁻¹T_{BC}.

Robustness to pose estimation errors While a proposed registration method works better with more accurate SfM results on NeRF-synthesized images, it is also robust to SfM's errors. When computing the relative scale, recovery involves at least two poses (e.g., so that at least one pair is formed to be used in Equation 4) from each NeRF's re-renderings. This is easily achievable with a sampled set of query poses. Moreover, because the median result is considered as the final estimation, the impact of erroneous poses will be minimal. A similar analysis also holds for transformation recovery, except that only a single pose is needed for the estimation.

### 1.2. NeRF Blending

Given two or more registered NeRFs and a query camera pose, NeRF blending aims to combine predictions from the individual NeRFs with the goal of high-quality novel view synthesis. Without loss of generality, again the two-NeRF settings are considered: A and B with relative transformation T_{BA}∈SIM(3). Let G_{B}∈SE(3) be a pose defined in NeRF B's coordinate system that can be used to query NeRF B. To get the corresponding pose G_{A} to query NeRF A, T_{BA}=G_{BA}S_{BA} is first decomposed, and G_{A}=T_{BA}G_{B}S_{BA}⁻¹ is computed.

For blending, there are three key concepts to consider: (i) when to blend: in what case should it be used; (ii) what to blend: at what granularity should it happen; and (iii) how to blend: in which manner are blending weights computed? Various aspects of the present disclosure answer these questions as follow: (i) with visibility thresholding, where if the mean visibility of a frame (predicted by a visibility network) is above a certain threshold then blending is activated. Afterwards, it answers (ii) by introducing image- and pixel-wise blending. Finally, it manages (iii) by inverse-distance-weighting (IDW) and predicted visibility weighting. Importantly, to achieve any of these results, a visibility prediction network has to be trained jointly with the NeRF and used during inference. In the disclosed setting, access to a visibility network is not assumed, because aspects of the present disclosure deal with black-box uncalibrated NeRFs not generated for this particular purpose.

Various aspects of the present disclosure answer question (i) by proposing a simpler threshold that is solely based on distance. The aspects of the present disclosure answer question (ii) by proposing a novel sample-based blending method recognizing the fact that the color of a pixel is computed using samples along the ray in NeRF during volumetric rendering. Additionally, the aspects of the present disclosure answer (iii) by proposing an IDW method for sample-based blending. Since IDW is used with sample-based blending, as described, we refer to this method as IDW-Sample. Without loss of generality, the blending of two registered NeRFs, A and B is discussed. These aspects of the present disclosure easily extend to an arbitrary number of NeRFs and also to any volumetric representation.

### 1.2.1 Distance Test for NeRF Selection

The decision of when to render using blended NeRFs, rather than just one NeRF, is an important question, because NeRFs can only render with high quality within their effective range. Rendering using distant NeRFs, whose rendering quality is poor, can only be harmful. Hence, a test based on the distance between the origin of the query camera and the NeRF centers is introduced. Denoting the distances from NeRF A and NeRF B as d_{A} and d_{B}, the test value is

$$τ = max ( \frac{{d}_{A}}{{d}_{B}} , \frac{{d}_{B}}{{d}_{A}} ) .$$

If τ is greater than a threshold, it means that the second closest NeRF is sufficiently far, in which case it is better to simply use the rendering of the closest NeRF to the query camera; otherwise, IDW-based blending is enabled.

### 1.2.2 IDW-Sample for NeRF Blending

During the NeRF's volumetric rendering stage, a pixel's color is computed using samples along the way. Recognizing this fact, a sample-wise blending method is proposed that calculates the blending weights for each ray sample using IDW. These aspects of the present disclosure show that the original volumetric rendering methodology can be easily extended to take advantage of these new sample-wise blending weights, resulting in the proposed IDW-Sample strategy.

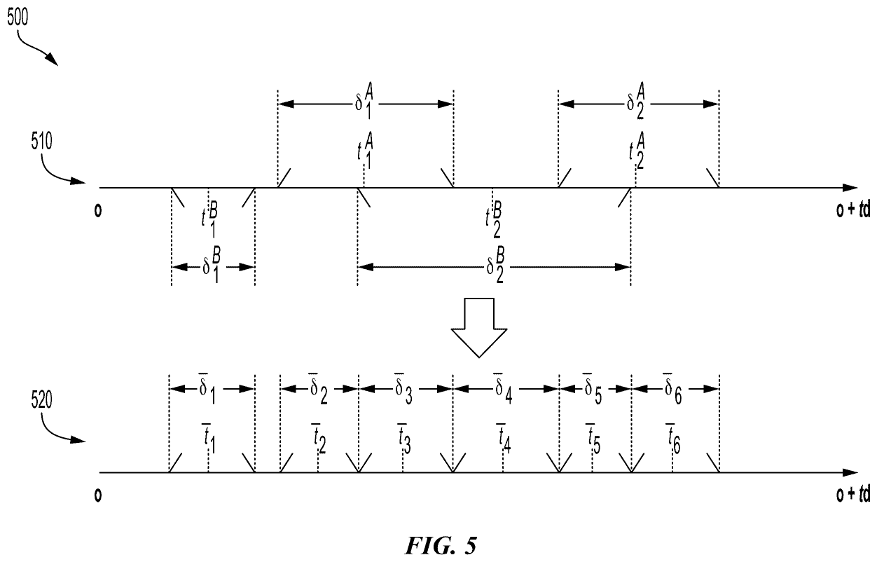

Merge Ray Samples Consider a pixel to be rendered, which gets unprojected into a ray. Because ray samples are separately proposed according to the density field of each source NeRF, the ray samples are merged into a single set. FIG. 5 provides an illustration 500 of how ray samples proposed by two NeRFs are merged based on their locations and lengths, according to various aspects of the present disclosure. As shown in FIG. 5, in a top portion 510: two sets of ray samples are proposed by NeRF A and NeRF B; and in a bottom portion 520: the single set of merged ray samples are shown.

As illustrated in FIG. 5, given samples {(tₖ^{A}, δₖ^{A})}ₖ and {(tₖ^{B}, δₖ^{B})}ₖ proposed from NeRF A and NeRF B, respectively, are merged into a single set of ray samples {(t̅ₖ^{B}, δ̅ₖ^{B})}ₖ by taking the sample location t and length δ. Additionally, sampling in the merged set is performed for each source NeRF. Given a ray sample proposed by an NeRF, it is assumed that a termination probability mass is uniformly distributed over its length, while its color is the same for any point within coverage.

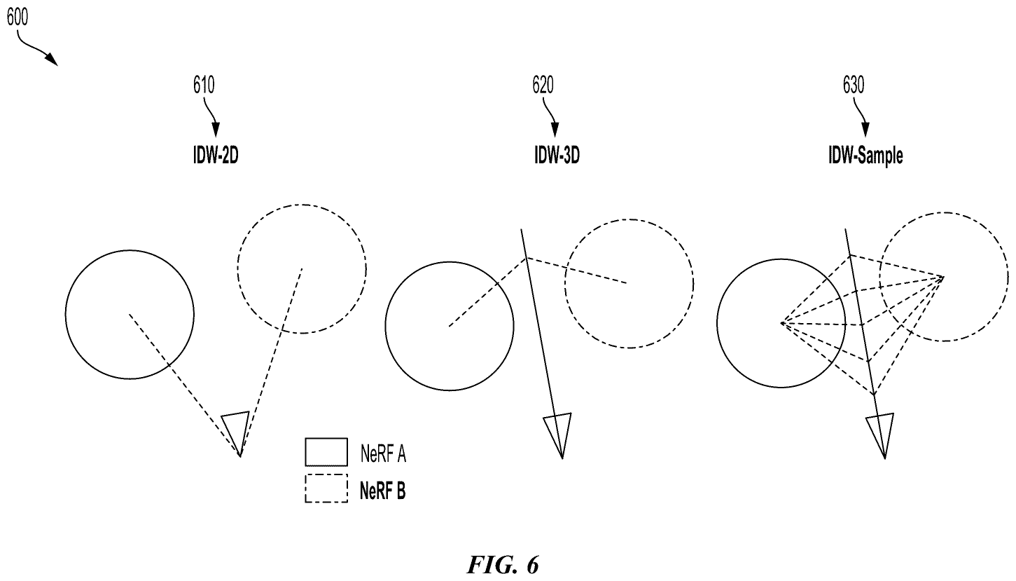

Blending Process Various aspects of the present disclosure use inverse-distance-weighting (IDW) to compute the blending weight for each sample. FIG. 6 shows an illustration 600 of IDW-based blending methods, according to various aspects of the present disclosure. In this example, IDW-2D 610 depends on the distance between camera center and NeRF centers, and IDW-3D 620 depends on the distance between estimated ray depth and the NeRF centers. By contract, IDW-Sample 630 depends on the NeRF centers and sample positions that are irrespective to depth quality, which is a major downside of IDW-3D.

Specifically, let xᵢ be the origin of NeRFᵢ for i∈{A, B}, o be the camera's optical center, r=(o, d) be the ray corresponding to pixel j to be rendered, and (t̅ₖ, \ddot{δ}ₖ) be a ray sample from the merged samples set. Additionally, blending weights are computed as w_{i,k}∝d_{i,k}^{-γ}, where d_{i,k}=∥xᵢ−(o+t̅ₖd)∥₂. The blended pixel j is:

$${I}^{( j )} = {\sum }_{k} {\sum }_{i} {w}_{i , k} {\overline{p}}_{i , k} , {\overline{c}}_{i , k} \qquad ( 5 )$$

Weights w_{i,k} are normalized following two steps: (i) Σᵢ w_{i,k}=1, ∀k; and (ii) ΣₖΣᵢw_{i,k}p̅_{i,k}=1. Step (i) indicates that the disclosed method does not change the relative weighting of samples along a given ray, which is already dictated by the termination probability. Step (ii) ensures that the rendered pixel has a valid color.

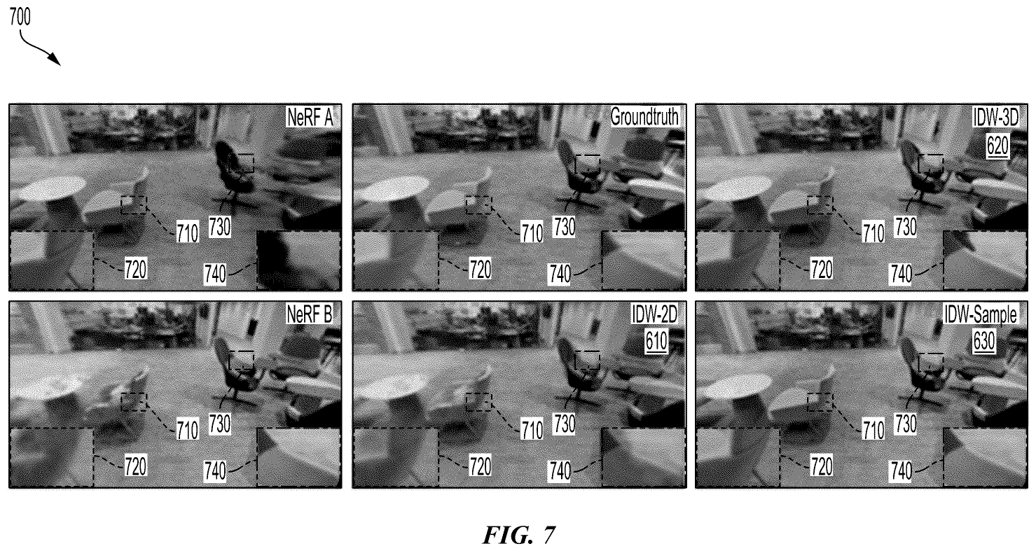

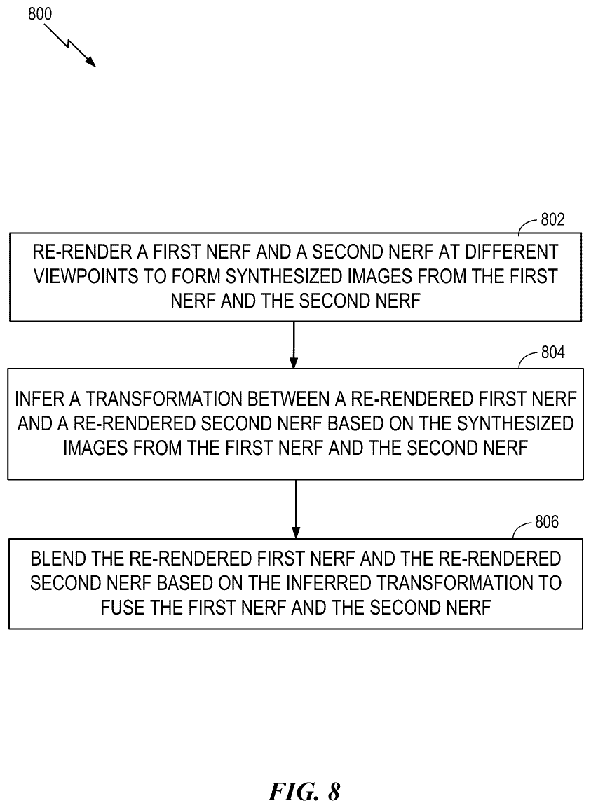

FIG. 7 illustrates a qualitative comparison 700 of the blending methods shown in FIG. 6, according to various aspects of the present disclosure. FIG. 7 illustrates an image representing a NeRF A, a NeRF B, a ground truth, the IDW-2D 610, the IDW-3D 620, and the IDW-Sample 630. In this example, each image includes a first highlighted portion 710, a first exploded portion 720, a second highlighted portion 730, and a second exploded portion 740. As shown in FIG. 7, the IDW-Sample 630 produces a high-quality blending for both chairs (e.g., 720 and 740), while baseline methods fail on at least one chair. It should be recognized that the blended results (e.g., IDW-Sample 630) are even sharper than the real test image, which exhibits motion blur, demonstrating an advantage of fusing information from multiple NeRFs. As shown in FIG. 7, an image quality of the IDW-Sample 630 is greater than images individually rendered by any one of the first NeRF or the second NeRF. A process for fusing neural radiance fields (NeRFs) is further illustrated in FIG. 8.

FIG. 8 is a flowchart illustrating a method for fusing neural radiance fields (NeRFs), according to aspects of the present disclosure. The method 800 begins at block 802, in which a first NeRF and a second NeRF are re-rendered at different viewpoints to form synthesized images from the first NeRF and the second NeRF. For example, as shown in FIG. 3, the perception module 310 is configured for fusing NeRFs by registration and blending in a NeRF fusion pipeline. The perception module 310 includes the re-render module 312 to re-render a first NeRF and a second NeRF at different viewpoints to synthesize images from the first NeRF and the second NeRF. FIG. 4 illustrates registration of two NeRFs, A and B.

At block 804, a transformation is inferred between a re-rendered first NeRF and a re-rendered second NeRF based on the synthesized images from the first NeRF and the second NeRF. For example, as shown in FIG. 3, the perception module 310 includes the transform inference model 314 to infer a transformation between a re-rendered first NeRF and a re-rendered second NeRF based on the synthesized images from the first NeRF and the second NeRF.

At block 806, the re-rendered first NeRF and the re-rendered second NeRF based are blended on the inferred transformation to fuse the first NeRF and the second NeRF. For example, as shown in FIG. 3, the perception module 310 includes the NeRF blending module 316 to blend the re-rendered first NeRF and the re-rendered second NeRF based on the inferred transformation to fuse the first NeRF and the second NeRF. Additionally, the perception module 310 includes the object manipulation module 318 to plan an object grasp by a robot according to a fused image from the first NeRF and the second NeRF. The fusing of NeRFs by registration and blending in a NeRF fusion framework is further illustrated, for example, as shown in FIG. 4.

In some aspects of the present disclosure, the method 800 may be performed by the SOC 100 (FIG. 1) or the software architecture 200 (FIG. 2) of the robot 150 (FIG. 1). That is, each of the elements of method 800 may, for example, but without limitation, be performed by the SOC 100, the software architecture 200, or the processor (e.g., CPU 102) and/or other components included therein of the robot 150.

A practical benefit of implicit visual representations, such as neural radiance fields (NeRFs) is their memory efficiency: large scenes can be efficiently stored and shared as small neural nets instead of collections of images. Nevertheless, operating on these implicit visual data structures requires extending classical image-based vision techniques (e.g., registration, blending) from image sets to neural fields. Towards this goal, various aspects of the present disclosure are directed to NeRFuser, a novel architecture for NeRF registration and blending that assumes only access to pre-generated NeRFs, and not the potentially large sets of images used to generate the NeRFs. These aspects of the present disclosure propose registration from re-rendering, a technique to infer the transformation between NeRFs based on images synthesized from individual NeRFs. For blending, a sample-based inverse distance weighting is proposed to blend visual information at the ray-sample level. Additionally, NeRFuser is evaluated on public benchmarks and a self-collected object-centric indoor dataset, showing the robustness of our method, including to views that are challenging to render from the individual source NeRFs.

The various operations of methods described above may be performed by any suitable means capable of performing the corresponding functions. The means may include various hardware and/or software component(s) and/or module(s), including, but not limited to, a circuit, an application-specific integrated circuit (ASIC), or processor. Where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Additionally, “determining” may include receiving (e.g., receiving information), accessing (e.g., accessing data in a memory), and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, and circuits described in connection with the present disclosure may be implemented or performed with a processor configured according to the present disclosure, a digital signal processor (DSP), an ASIC, a field-programmable gate array signal (FPGA) or other programmable logic device (PLD), discrete gate or transistor logic, discrete hardware components, or any combination thereof designed to perform the functions described herein. The processor may be a microprocessor, but in the alternative, the processor may be any commercially available processor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media may include random access memory (RAM), read-only memory (ROM), flash memory, erasable programmable read-only memory (EPROM), electrically erasable programmable read-only memory (EEPROM), registers, a hard disk, a removable disk, a CD-ROM, and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may connect a network adapter, among other things, to the processing system via the bus. The network adapter may implement signal processing functions. For certain aspects, a user interface (e.g., keypad, display, mouse, joystick, etc.) may also be connected to the bus. The bus may also link various other circuits, such as timing sources, peripherals, voltage regulators, power management circuits, and the like, which are well known in the art, and therefore, will not be described any further.

The processor may be responsible for managing the bus and processing, including the execution of software stored on the machine-readable media. Examples of processors that may be specially configured according to the present disclosure include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read-only memory (ROM), programmable read-only memory (PROM), crasable programmable read-only memory (EPROM), electrically crasable programmable read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in numerous ways, such as certain components being configured as part of a distributed computing system.

The processing system may be configured with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an ASIC with the processor, the bus interface, the user interface, supporting circuitry, and at least a portion of the machine-readable media integrated into a single chip, or with one or more PGAs, PLDs, controllers, state machines, gated logic, discrete hardware components, or any other suitable circuitry, or any combination of circuits that can perform the various functions described throughout the present disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a non-transitory computer-readable medium. Computer-readable media include both computer storage media and communication media, including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc; where disks usually reproduce data magnetically, while discs reproduce data optically with lasers. Thus, in some aspects computer-readable media may comprise non-transitory computer-readable media (e.g., tangible media). In addition, for other aspects, computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for fusing neural radiance fields (NeRFs), the method comprising:
re-rendering a first NeRF and a second NeRF at different viewpoints to form synthesized images from the first NeRF and the second NeRF;
inferring a transformation between a re-rendered first NeRF and a re-rendered second NeRF based on the synthesized images from the first NeRF and the second NeRF; and
blending the re-rendered first NeRF and the re-rendered second NeRF based on the inferred transformation to fuse the first NeRF and the second NeRF.

2. The method of claim 1, in which the first NeRF and the second NeRF comprise representations of a 3D scene.

3. The method of claim 1, in which blending comprises compositing predictions from the first NeRF and the second NeRF to form blended images having an image quality greater than images individually rendered by any one of the first NeRF or the second NeRF.

4. The method of claim 1, in which a scene is represented by a plurality of NeRFs.

5. The method of claim 1, in which each of the plurality of NeRFs having a neighbor NeRF.

6. The method of claim 1, further comprising training the first NeRF and the second NeRF on a separate set of images.

7. The method of claim 6, in which the separate set of images capture different, overlapping, portions of the same scene.

8. The method of claim 1, further comprising planning an object grasp by a robot according to a fused image from the first NeRF and the second NeRF.

9. A non-transitory computer-readable medium having program code recorded thereon for fusing neural radiance fields (NeRFs), the program code being executed by a processor and comprising:
program code to re-render a first NeRF and a second NeRF at different viewpoints to form synthesized images from the first NeRF and the second NeRF;
program code to infer a transformation between a re-rendered first NeRF and a re-rendered second NeRF based on the synthesized images from the first NeRF and the second NeRF; and
program code to blend the re-rendered first NeRF and the re-rendered second NeRF based on the inferred transformation to fuse the first NeRF and the second NeRF.

10. The non-transitory computer-readable medium of claim 9, in which the first NeRF and the second NeRF comprise representations of a 3D scene.

11. The non-transitory computer-readable medium of claim 9, in which the program code to blend comprises program code to composite predictions from the first NeRF and the second NeRF to form blended images having an image quality greater than images individually rendered by any one of the first NeRF or the second NeRF.

12. The non-transitory computer-readable medium of claim 9, in which a scene is represented by a plurality of NeRFs.

13. The non-transitory computer-readable medium of claim 9, in which each of the plurality of NeRFs having a neighbor NeRF.

14. The non-transitory computer-readable medium of claim 9, further comprising program code to train the first NeRF and the second NeRF on a separate set of images.

15. The non-transitory computer-readable medium of claim 14, in which the separate set of images capture different, overlapping, portions of the same scene.

16. The non-transitory computer-readable medium of claim 9, further comprising program code to plan an object grasp by a robot according to a fused image from the first NeRF and the second NeRF.

17. A system for fusing neural radiance fields (NeRFs), the system comprising:
re-render module to re-render a first NeRF and a second NeRF at different viewpoints to form synthesized images from the first NeRF and the second NeRF;
transform inference model to infer a transformation between a re-rendered first NeRF and a re-rendered second NeRF based on the synthesized images from the first NeRF and the second NeRF; and
NeRF blending module to blend the re-rendered first NeRF and the re-rendered second NeRF based on the inferred transformation to fuse the first NeRF and the second NeRF.

18. The system of claim 17, in which the NeRF blending module is further to composite predictions from the first NeRF and the second NeRF to form blended images having an image quality greater than images individually rendered by any one of the first NeRF or the second NeRF.

19. The system of claim 17, in which a scene is represented by a plurality of NeRFs and in which each of the plurality of NeRFs having a neighbor NeRF.

20. The system of claim 17, further comprising an object manipulation module to plan an object grasp by a robot according to a fused image from the first NeRF and the second NeRF.
